(19) United States
(12) Patent Application Publication
(10) Pub. No.: US 2023/0244926 A1
(43) Pub. Date: Aug. 3, 2023

(54) ENHANCING NEURAL-BASED PREDICTION OF MULTI-DIMENSIONAL DATA VIA INFLUENCE AND DATA AUGMENTATION

(71) Applicant: ADOBE INC., San Jose, CA (US)

(72) Inventors: Sungchul Kim, San Jose, CA (US); Sejoon Oh, Atlanta, GA (US); Ryan A. Rossi, San Jose, CA (US)

(21) Appl. No.: 17/592,186

(22) Filed: Feb. 3, 2022

(51) Int. Cl. G06N 3/08

(52) U.S. Cl. CPC G06N 3/08

(57) ABSTRACT

A data augmentation framework enhances the prediction accuracy of tensor completion methods. An array having a set of cells associated with a set of entities is received. Influence metrics of cells from the array are determined based on an influence of the cells on minimizing loss while training a machine learning model. An entity-importance metric is generated for each entity of the set of entities based on the influence metrics. A cell from the array for which to augment the array with a predicted value is identified. The cell is identified based on a sampling of the set of entities that is weighted by the entity-importance metric for each entity of the set of entities.

### BACKGROUND

Tensors (or arrays) are computational and/or mathematical objects employed for organizing, structuring, and storing “atoms” of data. An array (or tensor) may include one or more cells (or components), where each cell stores an “atom” of data (e.g., discrete values of data). An atom of data may include a single value, e.g., an integer, a float, a double, a char (e.g., a single character data type), a string of chars, or the like. A data atom may be a real number (e.g., a rational number if represented or stored via digital means), a complex number, or other such value. The cells or components of an array may be uniquely indexed (e.g., addressed) via a set of indices, where each index of the set of indices corresponds to a single dimension of the array. The number of indices required to uniquely refer to (or address) any particular data atom (e.g., a value) or cell is often referred to the order, rank, degree, or way of the array or tensor. Thus, the number of indices required to access a particular cell is equivalent to the order or rank of the array. The order (or rank) of an array may take on the value of any non-negative integer, without upper bound, i.e., order=0, 1, 2, 3, . . . .

For example, a 0^{th}-order tensor may represent (and/or store) a scalar object, a 1^{st}-order tensor may represent a vector object, and a 2^{nd}-order tensor may represent a matrix object. The order or rank of an array may be referred to as the dimensionality (e.g., D) of the array. For instance, a 1D array may store a (multi-dimensional) vector, a 2D array may store a M×N matrix, and the like. Note that the components of each “dimension” or 1D slice of the array may store a multi-dimensional object (e.g., a multi-dimensional vector). The dimensionality (e.g., the number of components/cells) associated with a particular 1D slice of an array (e.g., the portion of the array that is referenced by selecting a single index to vary, while holding all of the other indices constant) may be referred to as the length or depth of the corresponding 1D slice or dimension.

Multi-dimensional data (and thus tensors or arrays) are ubiquitous in computational settings. For example, multi-dimensional arrays are employed to store images, videos, numerical ratings, social networks, knowledge bases, and other such multidimensional data. At least due to the combinatorial explosion inherent with increasing dimensionality, an array may be large (e.g., the array includes a significant number of dimensions and/or a significant length or depth is associated with one or more of its dimensions).

Oftentimes, when accessed for processing, such a large array may be incomplete. That is, the data to be stored in a significant number of the array's cells is not (at least yet) available, or has yet to be generated, acquired, and/or collected. For such an incomplete array, a first portion of its cells may store “relevant” atoms of data, and an incomplete portion of its cells do not (yet) store a relevant value. For instance, when allocated, the cells may be initialized to store a “null” or “zero” value (e.g., a non-relevant value). As relevant data is collected, the relevant values may be stored in its corresponding cell. Thus, the array may be “filled-in” over time as data is generated or collected. Arrays or tensors that are significantly incomplete (i.e., a significant portion of their cells do not store a relevant value) may be referred to as “sparse” arrays or tensors.

### SUMMARY

The technology described herein is directed towards enhanced methods and systems for the prediction of multi-dimensional data via tensor-completion models. Some embodiments employ various statistical influence and data augmentation techniques to select certain cells of a tensor for augmentation and additionally employ one or more neural-based tensor-completion models to predict the multi-dimensional data.

Given a tensor with cells associated with a set of entities, various embodiments initially train a first machine learning model (e.g., a neural tensor-completion model) using cells from the tensor. Some non-limiting embodiments utilize influence functions to estimate the importance of at least a portion of the tensor's cells on minimizing loss at intervals during training of the first machine learning model. The influence functions may be employed to determine the importance for any cell of the tensor, including training cells, test cells, or any other cell (or component) of the tensor. In some embodiments, the importance for each of the training cells is estimated, via one or more influence functions. That is, some embodiments determine a cell-importance metric for each cell used to train the first machine learning model. Various embodiments compute the importance (e.g., entity-importance metric) of each entity associated with the tensor by aggregating the cell-importance metrics of the entity's associated training cells. For example, to compute the entity-importance metric associated with a particular entity of the tensor, the cell-importance metrics for each of the particular entity's associated cells may be combined to generate the entity-importance metric for the particular entity. The importance of an entity (e.g., as encoded by its corresponding entity-importance metric) signifies the entity's impact in reducing the prediction error.

Some embodiments select cells to augment and generate new data points (e.g., augmented cells) by sampling entities proportional to their entity-importance metrics. The new or augmented cells may form an augmented tensor. Values of the augmented tensor cells are predicted via a trained machine learning method (e.g., either the first machine learning model or a second machine learning model). This influence-based sampling of entities is employed to generate augmented data points by using important entities (e.g., as weighted by their entity-importance metrics in the sampling process), and thus, can lead to higher test prediction accuracy than conventional tensor completion methods, with associated decreased time and/or space complexities.

### BRIEF DESCRIPTION OF THE DRAWINGS

FIG. 1 illustrates an enhanced tensor completion system implementing various embodiments presented herein.

FIG. 2 illustrates an enhanced pipeline for automatically predicting missing values for an incomplete tensor, according to various embodiments presented herein.

FIG. 3 shows an exemplary embodiment of pseudo-code that may be employed to implement pipeline of FIG. 2, according to various embodiments.

FIG. 4A illustrates one embodiment of a method for completing a tensor, which is consistent with the various embodiments presented herein.

FIG. 4B illustrates another embodiment of a method for completing a tensor, which is consistent with the various embodiments presented herein.

FIG. 4C illustrates another embodiment of a method for completing a tensor, which is consistent with the various embodiments presented herein.

FIG. 5 is a block diagram of an example computing device in which embodiments of the present disclosure may be employed.

### DETAILED DESCRIPTION OF THE EMBODIMENTS

Many existing data-analysis schemes assume an input of a complete tensor or array. That is, these data-analysis schemes may fail when the input is a sparse array. Thus, investigations into tensor or array completion tasks (i.e., the task of predicting missing relevant values for an incomplete tensor's incomplete cells) constitute an active area of research. However, many conventional tensor completion methods lead to inaccurate or noisy predictions. Furthermore, as a consequence of the potential combinatorial explosion of large arrays, the time and/or space complexity of many such conventional methods results in computation-times that render the widespread adoption of these conventional methods infeasible or impractical.

The technology described herein is generally directed towards tensor or array completion methods and systems. As used throughout, the terms “tensor” and “array” may be employed interchangeably to refer to a mathematical and/or computational object that structures and/or stores atoms of data (e.g., data atoms) in cells or components of the tensor or array. As noted above, conventional tensor completion methods often impute significant errors when predicting missing values for incomplete tensors. Even if a particular conventional tensor completion method proves sufficiently accurate when predicting particular missing values for a particular incomplete tensor, the computational time and/or space complexities of such a conventional tensor completion method may be significant enough to render the wide deployment of the conventional method impractical or infeasible. The various embodiments overcome these and other limitations of conventional tensor completion methods, and provide enhancements over conventional methods, at least due in part to the statistical influence and data augmentation methods discussed throughout.

Various embodiments receive, as input, a “target” tensor that is an incomplete tensor and provide, as output, a complete (or near-complete) tensor, where the previously incomplete (or “empty”) cells are now storing relevant values. The relevant values for the newly-populated cells have been predicted and/or inferred (e.g., “interpolated”) from the relevant values stored in the target tensor, via the tensor completion methods and systems discussed herein. Some embodiments employ one or more tensor-completion (or array-completion) models to predict the missing relevant values. In various embodiments, a tensor-completion model is implemented by one or more neural networks, and thus may be referred to as a neural tensor-completion model. The one or more neural tensor-completion models may be trained via training data. As discussed throughout, data augmentation of the training data may be applied to generate more accurate predictions of the missing relevant values. That is, the embodiments leverage the strength of neural tensor-completion methods, and improve such neural tensor-completion methods via statistical influence and data augmentation.

To achieve such enhancements over conventional methods, various statistical methods, known as influence (or influence functions) are applied in the training of one or more tensor-completion models to determine “influential” training data points. During a data augmentation stage (of an automated pipeline implemented by the various embodiments), the entities of the training data may be sampled (weighted according to its associated influence) to generate augmented data points. Data augmentation increases the generalization capability of a model by generating new data points (e.g., augmented data points) for training a tensor-completion model. The augmented data points may be employed during the training of a second tensor-completion model, or to further train the initial completion model. Once trained, the completion model may predict or infer relevant values for the incomplete portions of the input target tensor.

In one non-limiting embodiment, the incomplete target tensor stores data that is employed in a recommendation system (e.g., a movie recommendation system). The relevant values stored in such a tensor for a movie recommendation system may include real (or at least rational, e.g., a float or double) numbers that indicate user-provided movie ratings. As used throughout, a tensor may be referenced via the script X. An input tensor to such a movie recommendation system may be a 3-rank tensor with the associated set of indices (i,j,k), where the index i indicates the i^{th} user of the system, the index j indicates the j^{th} movie of the system, and the index k indicates the k^{th} time slice of the recommendation system. Thus, the rating the i^{th} user gave to the j^{th} movie during the k^{th} time slice may be referenced as X_{(i,j,k)}. X may be an incomplete tensor when not every user has provided a rating to every movie during every time slice. The embodiments are enabled to predict values for unobserved tensor or array cells. Thus, some embodiments may receive (as input) an incomplete X (e.g., encoding values of movie ratings that some users provided for some movies during some time slices). Based on the incomplete target tensor, various embodiments predict movie ratings that are not included in the incomplete target tensor, e.g., movie ratings that the users did not actually provide, based on the ratings that the users did actually provide.

An “entity” of a tensor may refer to a particular value of particular index of the array, and its associated cells. Thus, an entity of a tensor may correspond to a sub-tensor (or sub-array) of the tensor. In the above movie recommendation scenario, an entity of the target tensor may refer to a particular user (and all their ratings), a particular movie (and all its ratings), or a particular time slice (and all the ratings provided during the particular time slice). An entity of a tensor may refer to a portion of the tensor (which is a sub-tensor of the tensor) that is referenced by holding a value of particular index constant constant, while varying each of the other indices across their corresponding ranges (e.g., the depth or length of the dimensions corresponding to the other indices). Thus an entity of a N-order tensor may be associated with a (N−1)-order tensor. A dimension of a tensor may refer to a 1D slice of the tensor. Thus, a dimension of a tensor may refer to a 1D array or a multidimensional vector object. A particular dimension of a tensor may be referenced by allowing a particular index to vary across its associated range, while holding the other N−1 indices constant. The “depth” or “length” of a dimension may refer to the dimensionality of the corresponding vector object. Each dimension of a tensor may have a separate depth or length. Accordingly, the index for a particular dimension may range from 1 to the positive integer corresponding to the length of the dimension. Furthermore, the number of entities corresponding to a tensor is the arithmetic sum of the lengths of each of its dimensions.

Various embodiments employ an influence-guided data augmentation technique, which may be referred herein as DAIN (Data Augmentation with INfluence Functions). At a high-level overhead, some embodiments train a first tensor-completion model (e.g., a neural tensor-completion model) with the input tensor (e.g., a received target tensor that is an incomplete tensor) and one or more training tensors. Cells of the target tensor may be referred to as target cells and cells of the one or more training tensors may be referred to as training cells. The dimensionality (and lengths of each dimension) of the training tensor may be equivalent to the dimensionality (and lengths of each dimension) of the incomplete target tensor.

Upon training the first tensor-completion model, various embodiments utilize influence functions to estimate the importance of each training cell (e.g., the importance of a rating in a movie rating tensor) on reducing imputation (or prediction) error. That is, the embodiments determine a cell-importance metric for each cell of the training data. Next, some embodiments compute the importance of every entity (of the training tensor) by aggregating the importance values (e.g., cell-importance metrics) of all its associated training cells. For example, to compute the importance of the entity (e.g., an entity-importance metric) associated with the particular user i, the importance of all the ratings given by the particular user associated with the particular value of i are aggregated or combined. The importance of an entity (e.g., as encoded by its corresponding entity-importance metric) signifies the entity's impact in reducing the prediction error. Specifically, for each entity, a cell-importance metric is calculated (via an influence function) for each of the entity's associated cells. The cell-importance metrics (for the cells associated with the entity) are aggregated across all of the entity's associated cells. The aggregation of the cell-importance metrics may be employed to determine an entity-importance metric for the entity.

Some embodiments then generate new data points (e.g., augmented cells) by sampling entities proportional to their entity-importance metrics. The new or augmented cells may form an augmented tensor. Values of the augmented tensor cells are predicted via a trained neural tensor completion method (e.g., either the first completion model or a second completion model). This influence-based sampling of entities is employed to generate augmented data points by using important entities (e.g., as weighted by their entity-importance metrics in the sampling process), and thus, can lead to higher test prediction accuracy than conventional tensor completion methods. Furthermore, as discussed below, various embodiments provide enhancements to the time and space complexities, over that of conventional tensor completion methods.

Tensor factorization (TF) is one such conventional method employed to predict missing values in a tensor. However, many conventional TF methods may exhibit high imputation error when estimating missing values in a tensor. One reason for the inaccuracy of conventional TF methods is that many TF models regard missing values in a tensor as zeros. Hence, when conventional TF models are trained with a sparse tensor, their predictions may be biased toward zeros, instead of the observed values. Other conventional TF methods attempt to improve their accuracy by focusing only on observed entries; however, these conventional TF methods may suffer from overfitting when the input tensor is very sparse.

Other conventional tensor completion methods include neural network-based tensor completion methods. However, these methods still suffer from data sparsity, and can become a bottleneck for neural tensor completion methods, which require a large amount of data for training. Moreover, these conventional neural networks-based methods may not generate new data points for data augmentation to solve the sparsity issue. That is, these conventional methods do not include the enhancement provided by data augmentation that the present embodiments do.

Accordingly, the embodiments include systems and methods that leverage the strength of neural tensor-completion models, and improves neural tensor-completion methods through the utilization of data augmentation. Data augmentation increases the generalization capability of a tensor-completion model by generating new (or augmented) data points while training the neural tensor-completion models. The data augmentation during the training enhances the models' prediction accuracy, and provides improvements to the time and space complexities, as compared to conventional tensor completion methods. Thus the embodiments include data augmentation techniques for enhancing neural tensor-completion models. The embodiments further include a framework for deriving the importance of tensor entities on reducing prediction error using influence functions. With the entity importance values (e.g., entity-importance metrics), new (e.g., augmented) data points are generated via weighted sampling and value predictions. The embodiments outperform conventional tensor completion methods on various real-world tensors in terms of prediction accuracy with statistical significance, as well as enhancements to the time and space complexity of the associated computations.

As used throughout, the terms “tensor” and “array” may be employed interchangeably to refer to an object that structures and/or stores atoms of data (e.g., data atoms). Accordingly, the “components” or values stored in the components of a tensor, may, but need not, transform via conventional covaraint or contravarient transformation laws. Furthermore, a tensor object need not be associated with a product of one or more conventional vector spaces. That is, as the term is used herein, a complete set of basis objects (e.g., state-vectors or functions) need not be considered to span a product of vector spaces associated with a tensor.

The term “data atom” may refer to a single discrete element of data. The data types of a data atom include, but are not limited to integers, floats, doubles, chars, strings, and the like. In some embodiments, a data type includes a real or complex object (e.g., a real or complex number). The terms “cell” or “component” are used interchangeably throughout to refer to the discrete elements (e.g., bins) of an array and/or tensor that stores an atom of data. Thus, a tensor or array may have or include a set of cells or set of components. Each cell or component of a tensor or array may be indexed, addressed, or referenced by an ordered set of indices, where the cardinality of the ordered set of indices is equivalent to the dimensionality, rank, order, or way of the array. Each index in the set of indices corresponds to exactly one of the dimensions of the array. Each cell may store a relevant or a non-relevant (e.g., a null) value. In at least one embodiment, a value of zero is considered as a non-relevant value. An “incomplete” tensor or array may be a tensor or an array, wherein at least one of its cells stores a non-relevant value. The term “sparse” may be applied to an incomplete tensor or array, wherein a significant number of its cells store a non-relevant value.

As used herein, the term “set” may be employed to refer to an ordered (i.e., sequential) or an unordered (i.e., non-sequential) collection of objects (or elements), such as but not limited to indices, machines (e.g., computer devices), physical and/or logical addresses, graph nodes, graph edges, and the like. A set may include N elements, where N is any non-negative integer. That is, a set may include 0, 1, 2, 3, . . . M objects and/or elements, where M is a positive integer with no upper bound. Therefore, as used herein, a set may be a null set (i.e., an empty set), that includes no elements (e.g., N=0 for the null set). A set may include only a single element. In other embodiments, a set includes a number of elements that is significantly greater than one, two, three, or billions of elements. A set may be an infinite set or a finite set. In some embodiments, “a set of objects” that is not a null set of the objects may be interchangeably referred to as either “one or more objects” or “at least one object.” A set of objects that includes at least two of the objects may be referred to as “a plurality of objects.”

As used herein, the term “subset,” is a set that is included in another set. A subset may be, but is not required to be, a proper or strict subset of the other set that the subset is included within. That is, if set B is a subset of set A, then in some embodiments, set B is a proper or strict subset of set A. In other embodiments, set B is a subset of set A, but not a proper or a strict subset of set A. For example, set A and set B may be equal sets, and set B may be referred to as a subset of set A. In such embodiments, set A is also referred to as a subset of set B. Two sets may be disjoint sets if the intersection between the two sets is the null set.

### Example Operating Environment for Tensor Completion

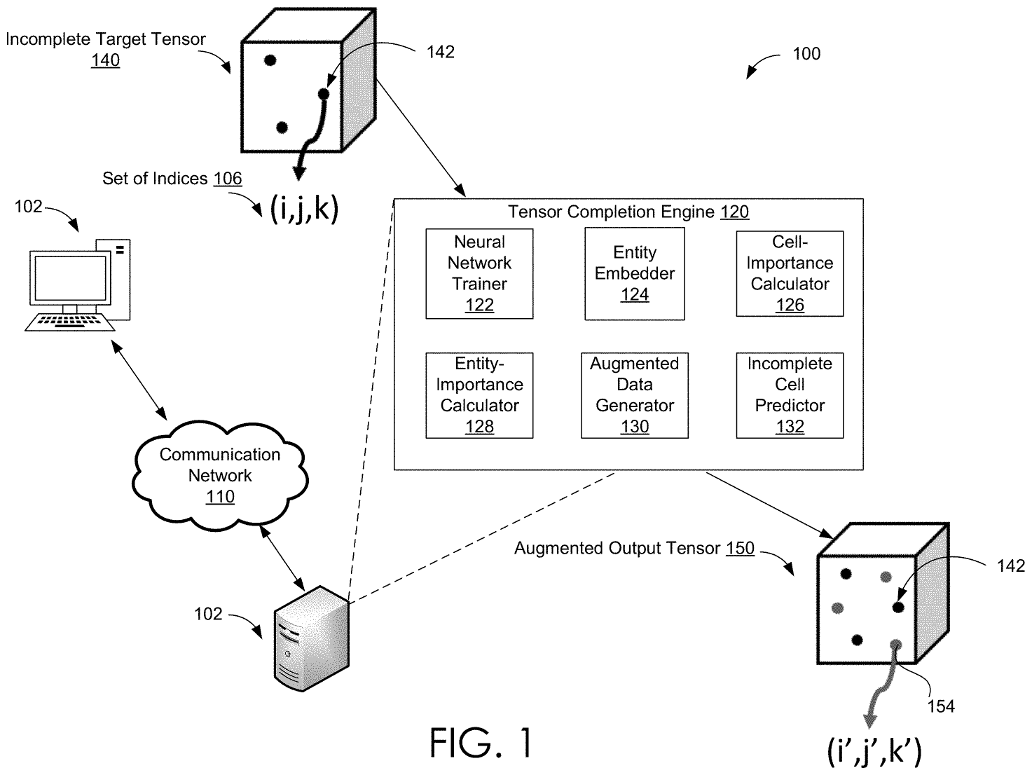

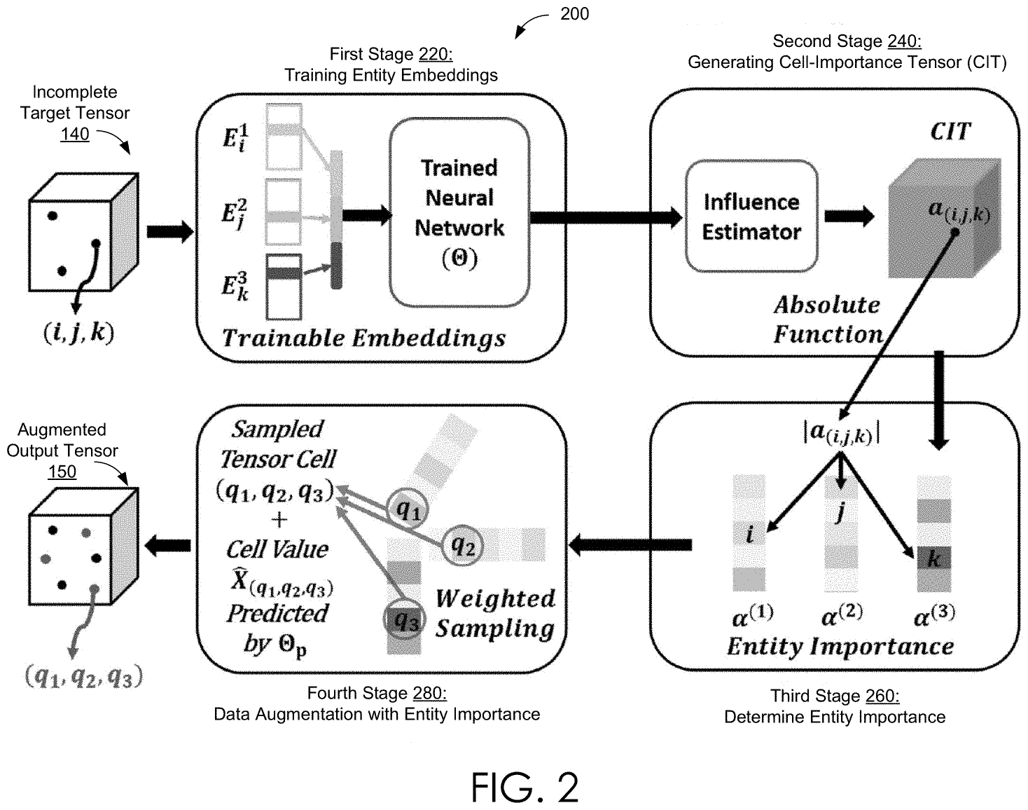

FIG. 1 illustrates an enhanced tensor completion system 100 implementing various embodiments presented herein. Tensor completion system 100 is enabled to automatically predict missing values for an incomplete input tensor (e.g., incomplete target tensor 140). Tensor completion system 100 may include at least a client computing device 102 and a server computing device 104, in communication via a communication network 110. The client computing device 102 can provide an incomplete tensor to the server computing device 104, via the communication network 110. The server computing device 104 implements a target completion engine 120. The tensor completion engine 120 is enabled to predict the values that are missing from the incomplete tensor (e.g., target tensor 140) and provide a “completed” tensor (e.g., the completed output tensor 150) to the client computing device 102, via the communication network 110. As discussed in conjunction with at least FIG. 2, the tensor completion engine 120 implements an automated pipeline (e.g., pipeline 200 of FIG. 2) that predicts the missing values for the incomplete cells of the input target tensor 140 and generates the completed output tensor 150. The pipeline 200 may employ various aspects of the DAIN method. Although a client/server architecture is shown in FIG. 1, the embodiments are not limited to such architectures. For example, client computing device 102 may implement the tensor completion engine 120, obviating the offloading of such tensor completion tasks to server devices.

In the non-limiting embodiment shown in FIG. 1, target tensor 140 is a 3^{rd}-order (or rank-3) tensor, that includes a set of target cells. Target tensor 140 may be referred to as a 3D array or tensor because it can be visualized as a 3D “block” of target cells, each of which is enabled to store an atom of data (e.g., a value). As shown in FIG. 1, each target cell of the set of target cells may be addressed and/or referenced via an ordered set of indices 106, e.g., (i,j,k). Because the number of indices required to reference or address a target cell are equivalent to the rank or dimensionality of a tensor, the cardinality of the set of indices 106 is three for the 3^{rd}-order tensor target 140. In a non-limiting embodiment, the incomplete target tensor 140 may be a movie recommendation tensor that stores movie ratings, where the value of the index i indicates a user, the value of the index j indicates a movie title, and the value of the index k indicates a time slice.

Because target tensor 140 is an incomplete tensor, a first subset of the set of target cells stores a relevant value (e.g., a movie rating provided by the corresponding user, for the corresponding movie, during the corresponding time slice) and a second subset of the set of target cells does not store a relevant value (e.g., the second subset of target cells may store a non-relevant value because the movie rating has not been provided by the corresponding user for the corresponding movie during the corresponding time slice). The first and second subset of target cells may be disjoint subsets of the set of target cells. The first and second subset of target cells may be complementary subsets of the set of target cells. The incompleteness of the target tensor 140 is demonstrated by the “sparseness” (or relatively low density) of the relevant values stored in the target cells. That is, the first subset of target cells (e.g., those target cells storing a relevant value in the target tensor 140) are represented by “dots” within the “block” of values stored in target tensor 140. One such target cell that stores a relevant value is shown as first target cell 142. The target cells of the second subset of target cells (e.g., those target cells that do not store a relevant value) are not visually shown in the target tensor 140. The specific index values (i, j, k) address or reference the first target cell 142.

Tensor completion engine 120 may receive the incomplete target tensor 140 as input, and generate a corresponding completed output tensor 150 as output, via pipeline 200. The output tensor 150 may be the completed “version” of the incomplete target tensor 106, where the “missing values” of the incomplete target tensor 106 have been predicted and “filled-in” via the tensor completion engine 120. Thus, the tensor completion engine 120 is enabled to perform the enhanced tensor completion tasks discussed herein. The increased density of dots shown in the completed output tensor 150 demonstrates the “filling-in” (with relevant values) of the target cells included in the second subset of target cells. For example, a second target cell 154 (which is included in the second subset of target cells) now stores a predicted relevant value. The specific index values (i′, j′, k′) address or reference the second target cell 154 that now stores a predicted relevant value (e.g., a predicted movie rating). Each of the target cells in the output tensor 150 may now store a relevant value. Some of the relevant values may be included in the target tensor 140 and other relevant values may have been predicted by the tensor completion engine 120. The output tensor 150 may be referred to throughout as a new tensor and/or an augmented tensor. As such, the rank (and length of each of its dimensions) of the output tensor 150 may match the rank (and corresponding lengths of its dimensions) of the target tensor 140. Thus, the cells of the output tensor are referenced via the set of indices 106.

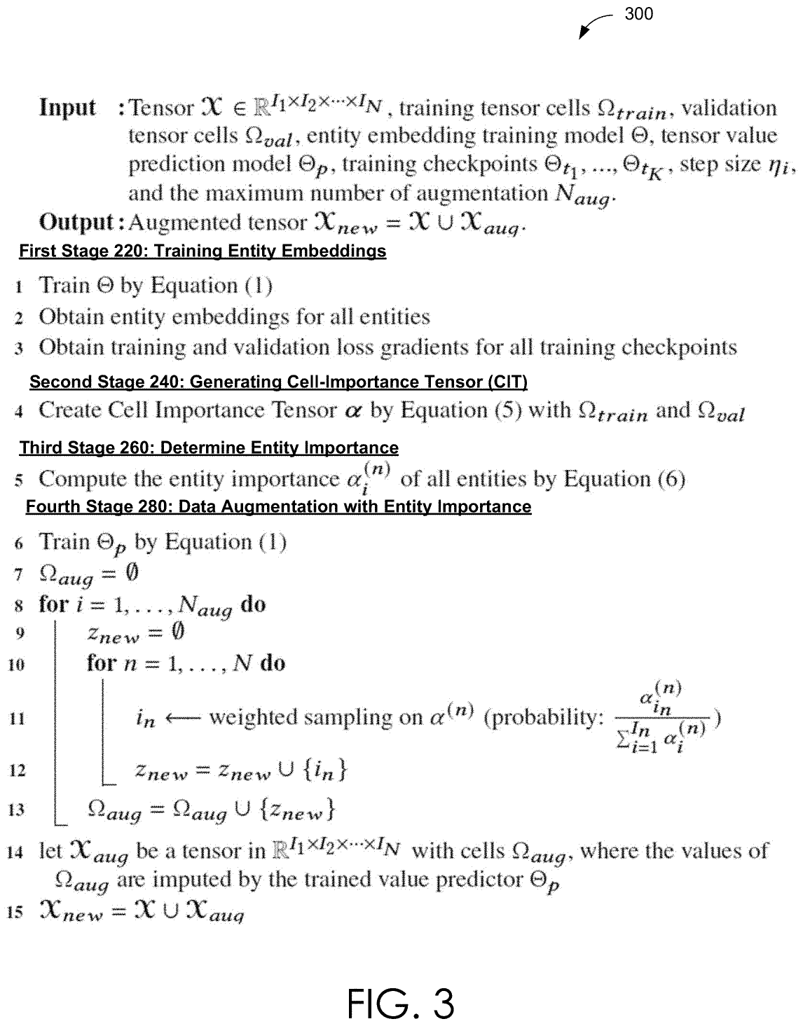

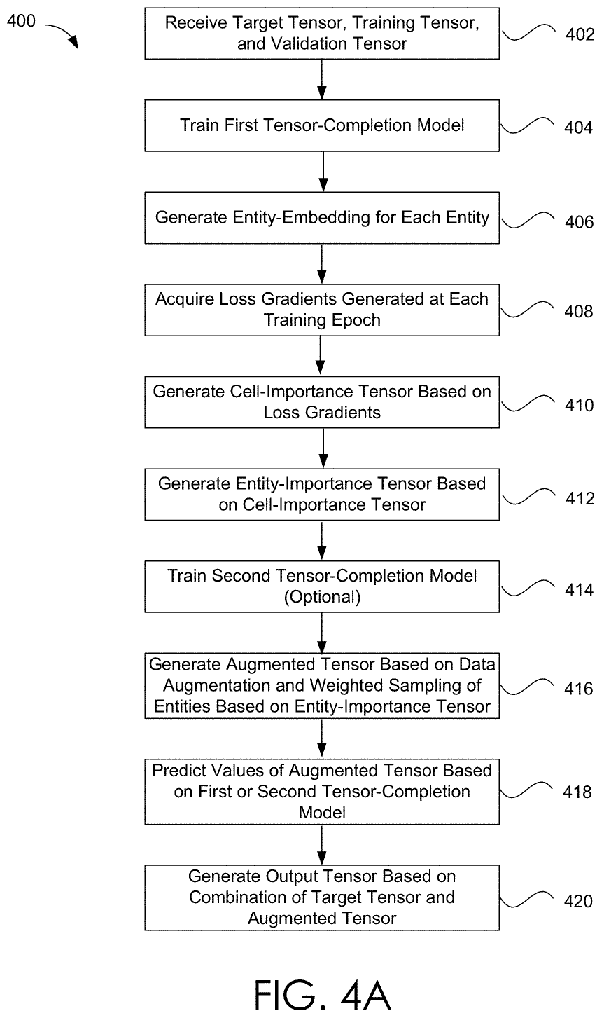

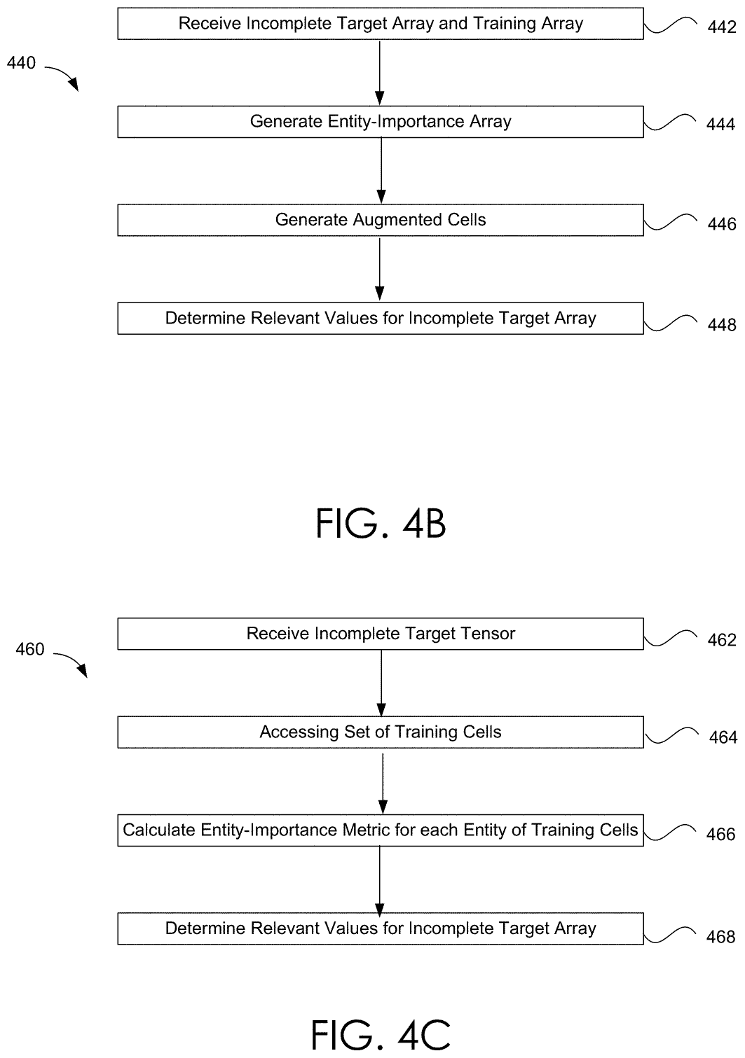

Tensor completion engine 120 may include a neural network trainer 122, an entity embedder 124, and a cell-importance calculator 126. In some embodiments, the tensor completion engine 120 may further include an entity-importance calculator 128, an augmented data generator 130, and an incomplete cell predictor 132. Other embodiments may include additional and/or alternative components to that shown in the exemplary embodiment of a tensor completion engine 120. The neural network trainer 122 is generally responsible for the training of one or more neural tensor-completion models discussed within. The entity embedder 124 is generally responsible for employing a neural network model to generate vector embeddings of cells and/or entities of tensors. The cell-importance calculator 126 is generally responsible for employing a loss signal (generated by the training of a neural network) to determine a cell-importance metric of each cell of a tensor when predicting missing values of a tensor. The entity-importance calculator 128 is generally responsible for aggregating the cell-importance metrics to determine an entity-importance metric for each entity of a tensor when predicting missing values of a tensor. The augmented data generator 130 is generally responsible for generating augmented data points as discussed herein. The incomplete cell predictor 132 is generally responsible for employing one or more tensor-completion models to predict the missing values of the target tensor 140 and generating the completed output tensor 150. The functionalities, operations, features, and actions implemented by the various components of tensor completion engine 120 are discussed at least in conjunction with pipeline 200 of FIG. 2, pseudo-code 300 of FIG. 3, and methods 400-460 of FIGS. 4A-4C.

Communication network 110 may be a general or specific communication network and may directly and/or indirectly communicatively coupled to client computing device 102 and server computing device 104. Communication network 110 may be any communication network, including virtually any wired and/or wireless communication technologies, wired and/or wireless communication protocols, and the like. Communication network 110 may be virtually any communication network that communicatively couples a plurality of computing devices and storage devices in such a way as to computing devices to exchange information via communication network 110.

### Notations Employed for Disclosing the Various Embodiments

Tensors (and arrays, as such terms are used interchangeably throughout) are mathematical and/or computational objects (e.g., data structures) that organize, structure, and store multi-dimensional data. Tensors include scalar objects (e.g., 0-order tensors), vectors objects (1-order tensors), matrix objects (2-order tensors), and higher order generalizations of such mathematical objects. As noted above, an N-way or N-order tensor has N dimensions, and the dimension size (e.g., dimensionality, length, or depth of each dimension) is denoted by I₁ through I_{N}, respectively. An N-order tensor may be denoted or referred to by boldface Euler script letters (e.g., X∈ [symbol] ^{I}^{₁}^{× . . . ×I}^{_{N}}). A tensor cell (i₁, . . . , i_{N}) stores or contains the value X₍ᵢ_{₁}_{, . . . , i}_{_{N}}₎, and an entity of a tensor refers to a single index of a dimension. For example, in the movie rating tensor case, an entity refers to a specific user, a specific movie, or specific time slice. Each cell of a tensor is enabled to store a rating, provided by the specific user, for the specific movie, and during the specific time slice corresponding to the specific values of (i,j,k). Table 1 lists various notations employed throughout.

TABLE 1
Table of Notations Employed Throughout.

| Symbol | Definition |
|---|---|
| x | input tensor |
| N | order of x |
| lₙ | dimensionality/size of the n^{th} dimension of x |
| (i₁, . . . , i_{N}) | cell of x |
| iₙ | entity of the n^{th} dimension of x |
| Ωₜᵣₐᵢₙ | set of train cells of x |
| Ωᵥₐₗ | set of validation cells of x |
| Ωₜₑₛₜ | set of test cells of x |
| α | cell importance tensor |
| ⁽¹⁾, . . . , α^{(N)} | entity importance |
| Eᵢⁿ | embedding of an entity i of the n^{th} dimension |
| θ | parameters of a tensor completion model |
| θₜ | parameters of a tensor completion model at epoch t |
| ηᵢ | step size at a checkpoint θₜ_{ᵢ} |
| θₜ_{₁}, . . . , θₜ_{_{K}} | checkpoints saved at epochs t₁, . . . , t_{K} |
| K | number of checkpoints |
| N_{aug} | number of data augmentation |
| T_{θ}, M_{θ} | time and space complexity of training entity embeddings |
| T_{θ}_{ₚ}, M_{θ}_{ₚ} | time and space complexity of training a value predictor |
| T_{infer} | time complexity of a single inference of a value predictor |
| D | dimension of a gradient vector |

As used throughout, the term tensor (or array) completion may refer to the process of predicting the missing values of a partially observed (e.g., an incomplete) tensor. The enhanced tensor completion methods employed by the various embodiments may include training one or more tensor-completion models by iteratively adjusting the values of the model's parameters (or weights) by employing observed cells (Ωₜᵣₐᵢₙ) to predict values of unobserved cells (Ωₜₑₛₜ) with the trained parameters. Specifically, given an N-order tensor X(∈ [symbol] ^{I}^{₁}^{× . . . ×I}^{_{N}}) with training data Ωₜᵣₐᵢₙ a tensor completion method aims to find model parameters Θ for the following optimization problem.

$${arg min}_{Θ} {\sum }_{∀ ( {i}_{1} , … , {i}_{N} ) ∈ {Ω}_{train}} {( {𝓍}_{( {i}_{1} , … , {i}_{N} )} - {\hat{𝓍}}_{( {i}_{1} , … , {i}_{N} )} )}^{2} \qquad ( 1 )$$

where \hat{X}ᵢ_{₁}_{, . . . ,i}_{_{N}}₎=Θ(i₁, . . . , i_{N}) is a prediction value for a cell (i₁, . . . , i_{N}) generated by the tensor completion method Θ. In some embodiments, a tensor-completion model referred to as CP (CANDECOMP/PARAFAC) factorization may be employed to make the prediction as follows:

$${\hat{𝓍}}_{( {i}_{1} , … , {i}_{N} )} = {\sum }_{r = 1}^{R} {\prod }_{n = 1}^{N} {U}_{{i}_{n} , r}^{n}$$

where R is a target factorization rank, and U¹, . . . , U^{N} are referred to as factor matrices. Various neural tensor completion methods employed within may utilize different neural network architectures to compute \hat{X}₍ᵢ_{₁}_{, . . . , i}_{_{N}}₎.

In various embodiments, a root-mean-square error (RMSE) metric may be employed to measure the accuracy of a tensor completion method. Specifically, a test RMSE may be utilized to check how accurately a tensor completion model predicts values of unobserved tensor cells. The formal definition of test RMSE is given as follows.

$$Test - RMSE = \sqrt{\frac{1}{\vert {Ω}_{test} \vert} {\sum }_{∀ ( {i}_{1} , … , {i}_{N} ) ∈ {Ω}_{test}} {( {𝓍}_{( {i}_{1} , … , {i}_{N} )} - {\hat{𝓍}}_{( {i}_{1} , … , {i}_{N} )} )}^{2}} \qquad ( 2 )$$

Notice that a tensor completion model with the lower test RMSE is more accurate.

Various embodiments may employ an influence estimator referred to as the TRACIN influence estimate. The TRACIN influence estimator may be employed to calculate the importance of every training data point in reducing test loss. This is done by tracing training and test loss gradients (e.g., a loss signal) with respect to model checkpoints, where checkpoints are the model parameters obtained at regular intervals during the training (e.g., at the end of every training epoch). The influence of a training data point z on the loss of a test data point z′ is given as follows:

$$Inf ( z , {z}^{′} ) \approx {\sum }_{i = 1}^{K} {η}_{i} ∇ ℓ ( {Θ}_{{t}_{i}} , z ) \cdot ∇ ℓ ( {Θ}_{{t}_{i}} , {z}^{′} ) \qquad ( 3 )$$

where Θₜ_{ᵢ}, 1≤i≤K are checkpoints saved at epochs t₁, . . . , t_{K}, ηᵢ is a step size at a checkpoint Θₜ_{ᵢ}, and ∇ [symbol] (Θₜ_{ᵢ}, z) is the gradient of the loss of z with respect to a checkpoint Θₜ_{ᵢ}.

Influence estimation with TRAM has clear advantages in terms of speed and accuracy over conventional methods, such as but not limited to conventional influence function-based methods and conventional representer point methods. The various embodiments may utilize TracIn to generate a cell-importance tensor.

### Automated Pipeline for Tensor Completion

FIG. 2 illustrates an enhanced pipeline 200 for automatically predicting missing values for an incomplete tensor, according to various embodiments presented herein. Pipeline 200 may be implemented by a tensor completion engine, such as but not limited to tensor completion engine 120 of FIG. 1. As such, pipeline 200 may receive an incomplete target tensor (e.g., incomplete target tensor 140 as discussed in conjunction with FIG. 1) and generate a completed output tensor (e.g., completed output tensor 150 as discussed in conjunction with FIG. 1). FIG. 2 will be discussed in conjunction with FIG. 3. FIG. 3 shows an exemplary embodiment of pseudo-code 300 that may be employed to implement pipeline 200 of FIG. 2.

Pipeline 200 may include four stages. The first stage 220 is generally responsible for training entity embeddings. An entity embedding may be a vector representation of the entity. The second stage 240 is generally responsible for generating a cell-importance tensor (CIT). The third stage 260 is generally responsible for determining an entity importance for each entity of a set of entities associated with the target tensor 140. The fourth stage 280 is generally responsible for performing data augmentation based on the entity importance and generating the completed output tensor 150 based on the data augmentation.

In pseudo-code 300 of FIG. 3, the “Input” line lists and describes the various inputs into the pipeline 200 of FIG. 2. Similarly, the “Output” line lists and describes the output of pipeline 200. More particularly, the input to pipeline 200 includes the incomplete target tensor 140 (referred to as X in pseudo-code 300), as well as training tensor cells (referred to as Ωₜᵣₐᵢₙ in pseudo-code 300), validation tensor cells (referred to as Ωᵥₐₗ in pseudo-code 300), an entity embedding training model (e.g., a first tensor-completion model referred to as Θ in pseudo-code 300), and a tensor value prediction model (e.g., a second tensor-completion model referred to as Θₚ in pseudo-code 300)). The output includes the augmented output tensor 150 (referred to as X_{new} in pseudo-code 300), which includes a union of the incomplete target tensor 140 and an augmented tensor (e.g., X_{aug}) generated in the fourth stage 280 of pipeline 200.

As indicated in pseudo-code 300, lines 1-3 of pseudo-code 300 refer to actions that are performed in the first stage 220 of pipeline 200. Line 4 of pseudo-code 300 refers to actions that are performed in the second stage 240 of pipeline 200. Line 5 of pseudo-code 300 refers to actions that are performed in the third stage 260 of pipeline 200. Lines 6-15 of pseudo-code 300 refer to actions that are performed in the fourth stage 280 of pipeline 200.

The enhanced methods and techniques (collectively referred herein as DAIN) employed via the embodiments may be implemented by a tensor completion engine, as demonstrated by the four stages of pipeline 200 of an enhanced tensor completion engine (e.g., tensor completion engine 120 of FIG. 1). Generally, in the first stage 220 of pipeline 200, entity embeddings are learned with training data. Training and validation loss gradients (e.g., loss signals) are acquired during the training of a first neural tensor-completion model (e.g., referenced as the trained neural network Θ). Accordingly, a neural network trainer (e.g., neural network trainer 122 of FIG. 1) and an entity embedder (e.g., entity embedder 124 of FIG. 1) may carry out various functionalities during the first stage 220. During the second stage 240 of pipeline 200, the tensor completion engine determines cell importance values (e.g., cell-importance metrics) by the influence estimator TracIn and generates a cell-importance tensor (CIT), which encodes cell-importance metrics (e.g., α_{(i,j,k)}). Thus, a cell-importance calculator (e.g., cell-importance calculator 126 of FIG. 1) may carry out various functionalities during the second stage 240.

In the third stage 260 of pipeline 200, the tensor completion engine uniformly distributes cell-importance metrics to the corresponding entities, and determines an entity-importance metric (α⁽ⁿ⁾) for each entity by aggregating the corresponding cell-importance metrics. The entity-importance metrics may be encoded in an entity-importance tensor, e.g., a 1D array. Accordingly, an entity-importance calculator (e.g., entity-importance calculator 128 of FIG. 1) may carry out various functionalities during the third stage 260. In the fourth stage 280 of pipeline 200, the tensor completion engine may perform data augmentation to the target tensor 140 by weighted sampling on those entity importance arrays to generate augmented data points. Thus, a augmented data generator (e.g., augmented data generator 130 of FIG. 1) may carry out various functionalities during the fourth stage 280. Also in the fourth stage 280, the tensor completion engine may employ a second neural tensor completion model (or the first neural tensor completion model trained in the first stage 220) and the augmented data points to predict the missing values to the target tensor 140 and generate the completed output tensor 150. Thus, the neural network trainer and an incomplete cell predictor (e.g., incomplete cell predictor 132 of FIG. 1) may carry out various functionalities of the fourth stage 280. Note that a tensor completion engine (e.g., tensor completion engine 120 of FIG. 1) can may employ any tensor-completion models (or combinations of multiple models) to learn entity embeddings (e.g., in the first stage 220) and predict values of sampled tensor cells (e.g., in the fourth stage 280) based on data augmentation.

More specifically, in the first stage 220 of pipeline 200, the neural completion engine may employ a neural network trainer (e.g., neural network trainer 122 of FIG. 1) to train a first tensor-completion model to learn vector embeddings for each entity of a set of entities associated with an incomplete input tensor (e.g., incomplete target tensor 140). The first tensor-completion model may be a neural tensor-completion model, and be referred to as Θ throughout. As noted above, the target tensor 140 may be a movie rating tensor, where the index i indicates a user, the index j indicates a movie, and the index k indicates a time slice. Thus, each entity may be associated with a specific user, a specific movie title, or a specific time slice.

Also in the first stage 220 of pipeline, an entity embedder (e.g., entity embedder 124 of FIG. 1) may employ the trained first neural completion model to generate a vector embedding for each entity associated with the target tensor 140. Because the number of data points (e.g., the number of cells) in a tensor may be large (e.g., due to the combinatorial explosion inherent in the growth of dimensionality), rather than employing one embedding per data point, the various embodiments may employ one embedding per entity. Thus, in the exemplary embodiment of a 3-rank tensor for the movie recommendation system, each entity may represent a single user, a single movie, or a single time slice. Each tensor cell can then be represented as an ordered concatenation of the embeddings of its entities. For example, a tensor cell (i₁, . . . , i_{N}) can be represented as Eᵢ_{₁}¹, Eᵢ_{₂}², Eᵢ_{₃}³, . . . ], where Eᵢ_{ₙ}ⁿ is an embedding of an entity iₙ associated with the n^{th} dimension of the tensor. The models may be trained to generate entity embeddings that enable accurate prediction of the values of the (training) data points in the tensor.

The neural network trainer may train an end-to-end trainable neural network (e.g., the first tensor-completion model) to learn such entity embeddings (e.g., see line 1 of pseudo-code 300 of FIG. 3). In some non-limiting embodiments, a multilayer perceptron (MLP) model with rectified linear unit (ReLU) activation function may be employed as the first tensor completion model. In other embodiments, a neural tensor factorization (NTF) model may be employed as the first tensor-completion model. In still other embodiments, a convolutional neural network (CNN)-based model, such as but not limited to a convolutional sparse tensor completion (CoSTCo) model may be employed for the first tensor-completion model. The trained model's prediction value for a tensor cell (i₁, . . . , i_{N}) may be defined by the following.

Z₁=ϕ₁(W₁[Eᵢ_{₁}¹, . . . ,Eᵢ_{_{N}}^{N}]+b₁), . . . ,

Z_{M}=ϕ_{M}(W_{M}Z_{M-1}+b_{M})

\hat{X}₍ᵢ_{₁}_{, . . . ,i}_{_{N}}₎=W_{M+1}Z_{M}+b_{M+1} (4)

Note that, in equation 4, [Eᵢ_{₁}¹, . . . ,Eᵢ_{_{N}}^{N}] represents the embedding of a cell (i₁, . . . , i_{N}) obtained by concatenating embeddings of entities i₁, . . . , i_{N}. \hat{X}₍ᵢ_{₁}_{, . . . , i}_{_{N}}₎ is the imputed output value by the first tensor-completion model for a cell (i₁, . . . , i_{N}). M indicates the number of hidden layers. W₁, . . . , W_{M+1} and b₁, . . . , b_{M+1} are weight matrices and bias vectors, respectively. ϕ₁, . . . , ϕ_{M} are activation functions (e.g., various embodiments may employ ReLU as an activation function). The first tensor-completion model's parameters W₁, . . . , W_{M+1} and b₁, . . . , b_{M+1} are referred to as Θ. By minimizing the loss function in equation (1) combined with equation (4), the entity embedder may generate trained entity embeddings as well as a loss signal (e.g., loss gradients) for all training and validation cells. The generation of entity embeddings and acquisition of a loss signal are referred to in lines 2-3 of pseudo-code 300 of FIG. 3. The loss signal may include gradient vectors, that a cell-importance calculator (e.g., cell-importance calculator 126 of FIG. 1) may employ in the second stage 240 of pipeline 200 to compute cell-level importance metrics.

More specifically, in the second stage 240 of the pipeline 200, a cell-importance calculator (e.g., cell-importance calculator 126 of FIG. 1) may generate a cell-importance tensor (CIT or α), which represents the importance of every tensor cell in reducing the prediction loss. Each cell of the CIT may store a cell-importance metric for the corresponding cell of the training tensor. In the movie rating tensor example, CIT stores the importance of ratings. The cell-importance calculator may employ any influence estimator to compute the cell-importance metrics. In various embodiments, a TracIn influence estimator may be employed. The cell-importance calculator may determine a value (e.g., a cell-importance metric) of a CIT cell z as discussed below. The calculation of the cell-importance metrics and generation of the CIT are referred to in line 4 of pseudo-code 300.

Equation (3) may be employed to compute the influence of a training cell z on the loss of a test cell z′. Since the test data may not be accessible, the influence α_{z} (e.g., the cell-importance metric) of a training cell z on reducing overall validation loss is computed by equation (5).

$${α}_{z} = \vert {\sum }_{z ′ ∈ {Ω}_{val}} Inf ( z , {z}^{′} ) \vert = \vert {\sum }_{z ′ ∈ {Ω}_{val}} {\sum }_{i = 1}^{K} {η}_{i} ∇ ℓ ( {Θ}_{{t}_{i}} , z ) \cdot ∇ ℓ ( {Θ}_{{t}_{i}} , {z}^{′} ) \vert \\ ⇔ {α}_{z} = \vert {\sum }_{i = 1}^{K} {η}_{i} ∇ ℓ ( {Θ}_{{t}_{i}} , z ) \cdot ( {\sum }_{z ′ ∈ {Ω}_{val}} ∇ ℓ ( {Θ}_{{t}_{i}} , {z}^{′} ) ) \vert . \qquad ( 5 )$$

Note that K in equation 5 is the number of checkpoints, ηᵢ is a step size at a checkpoint Θₜ_{ᵢ}, and ∇ [symbol] (Θₜ_{ᵢ},z) is the gradient of the loss of z with respect to a checkpoint Θₜ_{ᵢ}. As shown in FIG. 2, an absolute function (e.g., |α_{(i,j,k)}|) may be employed in the calculation of the α_{z} cells (e.g., on the cell-importance metrics) since cells with negative influence can also be important. For example, cells with large negative influence contribute to increasing the validation loss significantly. This loss increase may be mitigated via the data augmentation method (as implemented in the fourth stage 280), where the absolute function leads DAIN to create more augmentation for these cells. For instance, in the movie rating tensor example, the cell-importance metric captures the importance of the rating on the prediction loss, while it may not reflect the importance of a user, a movie, or a time slice. If the importance of every user, movie, and time slice (e.g., as encoded by the entity-importance metric), new influential data points (e.g., augmented data points) may be generated to minimize prediction error by combining users, movies, and time slices that have high importance values (e.g., large entity-importance metrics).

Such important entities are identified in the third stage 260 of pipeline. Identifying the most important entities may be beneficial for the various embodiments. The output of the second stage 240 includes a cell importance for each cells (e.g., as encoded in the CIT). The cell-importance metrics associated with the cells associated with a particular entity may be combined to calculate an entity-importance metric for the particular entity. For instance, in the movie rating tensor example, the cell-importance metric indicates the importance of the rating on the prediction loss, while it may not reflect the importance of the user, the particular movie, or the particular time slice that is associated with the cell (e.g., the movie rating). If the importance of entity (e.g., each user, movie, and time slice) is determined, new influential data points may be generated (via data augmentation in the fourth stage 280) to minimize prediction error by combining entities to have high importance values.

In the third stage 260, an entity-importance calculator (e.g., the entity-importance calculator 128 of FIG. 1) may employ an aggregation technique to calculate entity-importance metrics from cell-importance metrics. The calculation of entity-importance metrics from the aggregation of associated cell-importance metrics of the third stage 260 is referred to in line 5 of pseudo-code 300. For the aggregation (or combination) a cell's importance (e.g., as encoded in the cell's corresponding cell-importance metric) is uniformly distributed to its associated entities. For instance, given a training cell z=(i₁, . . . , i_{N}), the corresponding cell-importance metric (e.g., as encoded in α_{z}) is uniformly distributed to the cell's associated N entities {i₁, . . . , i_{N}}. After performing the allocation for all training cells, the entity-importance (e.g., αᵢ⁽ⁿ⁾) is calculated for an entity i of the n^{th} dimension by aggregating cell importance scores as indicated in equation 6

$${α}_{i}^{( n )} = {\sum }_{∀ ( {i}_{1} , … , {i}_{N} ) ∈ {Ω}_{train} , {i}_{n} = i} {α}_{( {i}_{1} , … , {i}_{N} )} . \qquad ( 6 )$$

Recall that α indicates the cell-importance tensor (CIT), and Ωₜᵣₐᵢₙ represents a set of training cells from a training tensor. In the movie rating tensor example, equation 6 indicates that a user's entity importance is the aggregation of the importance scores of all the ratings the user gives (over all time slices). Similarly, a movie's importance is the sum of the importance of the ratings it receives (e.g., from all users over all time slices), and the importance of a time slice is the sum of the importance of all the ratings given during the time slice (e.g., from all pairs of users and movies).

In at least one alternative embodiment, the entity-importance metrics may be calculated by applying rank-1 CP factorization (as discussed above) on the cell-importance tensor. The output factor matrices from the CP model include the entity-importance metrics. Specifically, a value of each output array indicates the importance of the corresponding entity on predicting values in a training tensor.

The loss function of the rank-1 CP model is given in equation 7.

$$L ( {α}^{( 1 )} , … , {α}^{( N )} ) = {\sum }_{∀ ( {i}_{1} , … , {i}_{N} ) ∈ {Ω}_{train}} {( \vert {α}_{( {i}_{1} , … , {i}_{N} )} \vert - {\prod }_{n = 1}^{N} {α}_{{i}_{n}}^{( n )} )}^{2} + λ {\sum }_{n = 1}^{N} {‖ {α}^{( n )} ‖}^{2} . \qquad ( 7 )$$

In equation 7, α⁽¹⁾, . . . , α^{(N)} indicates entity-importance metrics, λ is a regularization factor, and ∥X∥ is Frobenius norm of a tensor X. This aggregation scheme was selected to compute the entity-importance metrics as the rank-1 CP model may produce inaccurate decomposition results when a given tensor is highly sparse.

In the fourth state 280 of pipeline 200, the tensor cells and values are identified for data augmentation using the entity-important metrics and a value predictor, respectively. Lines 6-15 in pseudo-code refer to the operations of the fourth stage 280. A high entity-importance metric indicates that the corresponding entity plays an important role in improving the validation set prediction. Thus, new cells (e.g., augmented cells) are generated using these important entities. An augmented data generator (e.g., augmented data generator 130 of FIG. 1) may be employed to generated the augmented data points and/or augmented cells.

As referred to in line 6 of the pseudo-code 300, a neural network trainer (e.g., neural network trainer 122 of FIG. 1) may be employed to train a second tensor-completion model (e.g., second neural tensor completion model Θₚ) with the original training cells. An incomplete cell predictor (e.g., incomplete cell predictor 132 of FIG. 1) may employ this second tensor-completion model (or alternatively the first tensor-completion model) to predict the missing tensor values. After training the second tensor-completion model, a weighted sampling on every entity importance array may be performed. This sampling is referred to in line 11 of pseudo code 300. As indicated in line 12 of the pseudo-code 300, one entity from each dimension may be selected to generate a new (or augmented) data point. Mathematically, an entity i of the n^{th} dimension (e.g., a user among all users) has a probability

$$\frac{{α}_{i}^{( n )}}{{\sum }_{i = 1}^{{I}_{n}} {α}_{i}^{( n )}}$$

to be sampled. The sampled entities from all dimensions may be combined to form one augmented tensor cell. The generation of the augmented tensor cell is referred to in line 13 of pseudo-code 300. As shown in the for loops of lines 8-13 of pseudo-code 300, this process is repeated to generate the required number of data points for augmentation.

Once indices of the augmented cells are sampled, the incomplete cell predictor may predict their values by employing the second (or first) trained neural tensor-completion model. Generating such predicted values is referred to in line 14 of pseudo-code 300. In some embodiments, the overall average value

$$( i . e . , \frac{1}{\vert {Ω}_{train} \vert} {Σ}_{∀ ( {i}_{1} , … , {i}_{N} ) ∈ {Ω}_{train}} {𝓍}_{( {i}_{1} , … , {i}_{N} )} )$$

may be employed. In other embodiments, the most similar index in the embedding space is founds and the predicted values may be set to its value. In embodiments where these heuristics can be inaccurate and computationally expensive, respectively other, more advanced methods of value prediction may be employed.

In these other embodiments, the predicted values of the augmented data points may be assigned by predicting the values using a tensor completion model (either the previously trained first tensor-completion model (e.g., Θ) or the second trained tensor completion model (e.g., Θₚ)). Specifically, in some embodiments, the incomplete cell predictor can employ the trained entity embeddings generated via the first tensor-completion model (e.g., Θ) to predict the values. In other embodiments, the incomplete cell predictor can employ the second tensor-completion model (e.g., Θₚ) and the training data to predict the missing values.

Reusing the first tensor-prediction model (e.g., the trained neural network Θ) may be computationally cheaper since it only needs to do a forward pass for inference, which is fast. However, this may result in overfitting of the downstream model since the resulting augmentation cell values may be homogeneous with the original tensor. On the other hand, employing the second tensor-completion model Θₚ may increase the generalization capability of a downstream model by generating more heterogeneous data compared to the first tensor completion model Θ. Thus, in some embodiments, the second tensor-completion model Θₚ is employed in the fourth stage 280 of pipeline 200. In other embodiments, embodiments, the first tensor-completion model Θ is employed in the fourth stage 280 of pipeline 200. In some embodiments, the second tensor-completion model may include the CoSTCo model previously discussed, which is employed to predict the values of the augmented tensor cells. In other embodiments, the second tensor-completion model may be a MLP model or an NFT model.

After all tensor cell indices and values needed for augmentation are generated, these values and/or cells may be combined with the input target tensor 140 to generate an augmented tensor X_{new} (e.g., the completed output tensor 150). Generating the augmented and/or output tensor is referred to in line 15 of pseudo code 300. This augmented tensor can be used for downstream tasks, e.g., movie recommendations.

### Complexity Analysis of the Embodiments

In this section, the time and space complexities of the various embodiments are analyzed and quantified. Considering the time complexity of the embodiments, the first stage 220 of pipeline 200 includes training a neural tensor completion model (e.g., the first tensor-completion model Θ) to generate entity embeddings and gradients, which takes O(T_{Θ}) assuming O(T_{Θ}) is the time complexity of training Θ as well as gradient calculations. The second stage 240 of pipeline 200 includes computing the cell importance α_{z} for each training cell z∈Ωₜᵣₐᵢₙ. A naive computation of α_{z} in equation (5) for all training cells takes O(KD|Ωₜᵣₐᵢₙ∥Ωᵥₐₗ|), where K and D are the number of checkpoints and the dimension of the gradient vector, respectively. The computation of O(KD(|Ωₜᵣₐᵢₙ|+|Ωᵥₐₗ|)) may be accelerated by precomputing Σ_{Z′∈Ω}_{ᵥₐₗ}∇ [symbol] (Θₜ_{ᵢ}, z′) for all checkpoints Θₜ_{₁}, . . . , Θₜ_{_{K}} in equation (5). The third stage 260 of pipeline 200 includes calculating the entity importance with the aggregation technique by equation (6). It takes O(N|Ωₜᵣₐᵢₙ|) since α_{z} is distributed, ∀z∈Ωₜᵣₐᵢₙ to its entities and aggregate the assigned values. The fourth stage 280 of pipeline (e.g., the data augmentation stage) takes O(T_{Θ}_{ₚ}+N_{aug}(N log I+T_{infer})), where O(T_{Θ}_{ₚ}) and O(T_{infer}) are the training and single inference time complexities of the second tensor-completion model Θₚ, respectively. O(N_{aug}N log I) term indicates the time complexity of weighted sampling N_{aug} cells without replacement from N dimensions (assuming I₁= . . . =I_{N}=I). By combining the time complexity of the four stages of pipeline 200, the final time complexity of the embodiments may be determined as O(T_{Θ}+T_{Θ}_{ₚ}+(KD+N)|Ωₜᵣₐᵢₙ|+KD|Ωᵥₐₗ|+N_{aug}(N log I+T_{infer})).

Considering the space complexity of the embodiments, the first stage 220 of pipeline includes obtaining entity embeddings and gradients, which takes O(M_{Θ}+KD(|Ωₜᵣₐᵢₙ|+|Ωᵥₐₗ|)) space, assuming O(M_{Θ}) is the space complexity of training a neural tensor completion model (e.g., the first tensor-completion model Θ (including entity embeddings)). O(KD(|Ωₜᵣₐᵢₙ|+|Ωᵥₐₗ|)) space is required to store D-dimension gradients of training and validation cells for all K checkpoints. The second stage 240 of pipeline 200 includes computing the cell importance α_{z}, which takes O(|Ωₜᵣₐᵢₙ|) space since we need to store all cell importance values. The third stage 260 of pipeline 200 includes calculating the entity importance with the aggregation method, which takes O(NI) space since the entity-importance metrics of all entities from N dimensions (assuming I₁= . . . =I_{N}=I) need to be stored. Finally, the data augmentation stage (e.g., the fourth stage 280 of pipeline 200) takes O(M_{Θ}_{ₚ}+N_{aug} N) space since O(M_{Θ}_{ₚ}) space is required for training the second tensor-completion model Θₚ and O(N_{aug}N) space is required for storing the data augmentation with N_{aug} cells. By combining the space complexity of the four stages of pipeline 200, the final space complexity the embodiments may be determined as O(M_{Θ}+M_{Θ}_{ₚ}+KD(|Ωₜᵣₐᵢₙ|+|Ωᵥₐₗ|)+N(I+N_{aug})).

### Generalized Processes for Tensor Completion

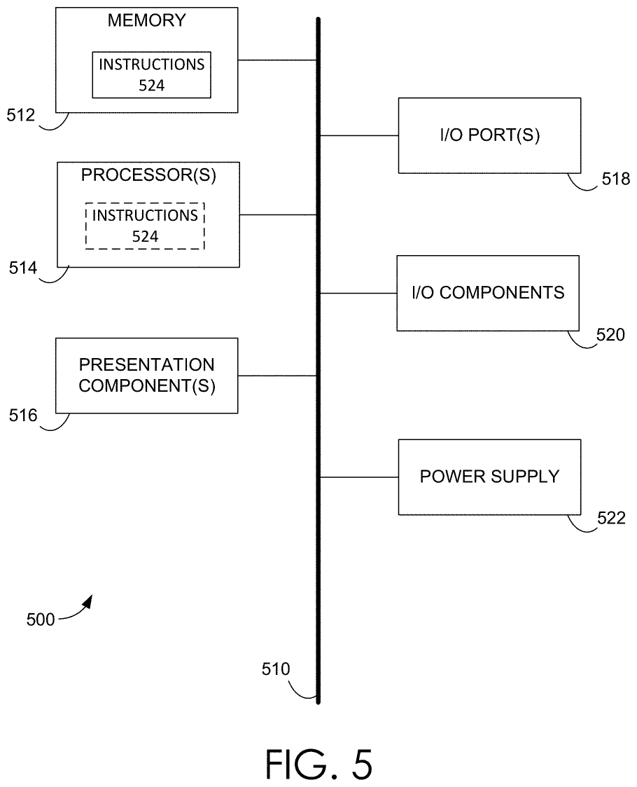

Processes 400-460 of FIGS. 4A-4C, or portions thereof, may be performed and/or executed by any computing device, such as but not limited to, client computing device 102 of FIG. 1, server computing device 104 of FIG. 1, and/or computing device 500 of FIG. 5. Additionally, a tensor completion mapper, such as but not limited to tensor completion engine 120 of FIG. 1, may perform and/or execute at least portions of processes 400-460.

FIG. 4A illustrates one embodiment of a method for completing a tensor, which is consistent with the various embodiments presented herein. Process 400 may be performed by a tensor completion engine, such as but not limited to tensor completion engine 120 of FIG. 1. As such, pipeline 200 of FIG. 2 may implement any combination of the various steps, actions, operations, and/or functionalities associated with any of the blocks of method 400. Likewise, any of the blocks of method 400 may implement any combinations of the various steps, actions, operations, and/or functionalities associated with any of the four stages of pipeline 200. For instance, blocks 402-408 of method 400 may employ any implementation details associated with at least the first stage 220 of pipeline 200, and vice-versa. Block 410 of method 400 may employ any implementation details associated with at least the second stage 240 of pipeline 200, and vice-versa. Block 412 of method 400 may employ any implementation details associated with at least the third stage 260 of pipeline 200, and vice-versa. Blocks 414-420 of method 400 may employ any implementation details associated with at least the fourth stage 280 of pipeline 200, and vice-versa. Furthermore, because pipeline 200 may implement various aspects of method 400, various blocks of method 400 may be implemented in pseudo-code 300 of FIG. 3, and vice-versa. That is, any of the lines of pseudo-code 300 may implement any of the aspects of method 400.

Process 400 begins at block 402, where each of a target tensor, a training tensor, and a validation tensor are received. The target tensor may include a set of target cells and be referenced throughout as X. The target tensor may be an incomplete tensor, e.g., incomplete target tensor 140 of FIG. 1. That is, the set of target cells may include a first subset of target cells that store a relevant value and a second subset of target cells that store a non-relevant value. The training tensor may include a set of training cells, which may be referred to as Ωₜᵣₐᵢₙ. The validation tensor may include a set of validation cells, which are referred to as Ωᵥₐₗ. In some non-limiting embodiments, a test tensor that includes a set of test cells may also be received at block 402. The set of test cells may be referred to as Ωₜₑₛₜ. Each of the sets of training, target, training, and test cells may be indexed via an ordered set of indices. Each entity of a set of entities of the training and target arrays may be characterized by holding a specific value of a specific index of the set of indices constant, while allowing values of other indices of the set of indices to vary across their associated ranges. The tensors may be received by a tensor completion engine, such as but not limited to tensor completion engine 120 of FIG. 1.

At block 404, a first tensor-completion model may be trained. The first tensor-completion model may be trained as indicated in line 1 of pseudo-code 300. As such, the first tensor-completion model may be a neural tensor-completion model, and referred to as Θ. In some embodiments, the first tensor-completion model may be a MLP model that employs a ReLU activation function. In other embodiments, the first tensor-completion model is a CoSTCo model. In at least one embodiment, the first tensor-completion model is NTF model.

The training of the first tensor-completion model may be performed as indicated by equation 1. A neural network trainer (e.g., neural network trainer 122 of FIG. 1) may be employed to train the first tensor-completion model based on the training tensor (e.g., by employing the set of training cells as training data). The training of the first tensor-completion model may include accessing at least one of the set of target cells, the set of training cells, the set of testing cells, and/or the set of validation cells. Estimated values for the test cells may be iteratively determined based on current weights of the first tensor-completion model and the training cells. A loss function may be iteratively calculated. The loss function may be based on equation 1. The calculation of the loss function may be based on the estimated values. The calculation of the loss function may be further based on the training cells. The current weights of the first array-completion model may be iteratively adjusted to decrease the loss function based on a loss signal determined from the loss function.

At block 406, for each entity of the set of entities, an entity-embedding may be generated based on the first tensor-completion model and the set of training cells. An entity embedder (e.g., entity embedder 124 of FIG. 1) may be employed to generate the entity embeddings. The entity embeddings may be generated and/or obtained as referenced in line 2 of pseudo-code 300. An entity embedding for the i^{th} entity of the n^{th} dimension may be referenced as Eᵢⁿ. A tensor cell (i₁, . . . , i_{N}) can be represented as [Eᵢ_{₁}¹, Eᵢ_{₂}², Eᵢ_{₃}³, . . . ], where Eᵢ_{ₙ}ⁿ is an embedding of an entity iₙ associated with the n^{th} dimension of the tensor. In at least one embodiment, for each training cell of the set of training cells, a cell-embedding may be generated based on a combination of the entity-embeddings for a subset of the set of entities that is associated with the training cell. At block 406, estimated values for a set of test cells based determined or predicted based on the cell-embedding for each of the training cells of the set of training cells. In at least MLP embodiments, the estimated values for the set of test cells may be based on equation 4.

At block 408, a training loss signal may be acquired, accessed, received, obtained, and/or generated. The loss signal may have been generated during the training of the first tensor-completion model. The loss signal may include a set of loss gradients generated during a plurality of epochs of the training of the first tensor-completion model. The loss gradients may be obtained as referenced in line 3 of pseudo-code 300. As such, the loss signal (and thus the loss gradients) may include training loss gradients and validation loss gradients for all the epochs of the training (e.g., at all training checkpoints). Therefore, the loss signal may be based on the estimated values for the set of test cells determined in block 406. The loss signal may be received from the neural network trainer. The loss signal may be received at a cell-importance calculator (e.g., cell-importance calculator 126 of FIG. 1).

At block 410, a cell-importance tensor (CIT) may be generated based on the loss signal. A cell-importance calculator may generate the cell-importance tensor and calculate the cell-importance metrics stored within its cells. The cell-importance tensor may be referred to as α. Generating the cell-importance tensor is referenced in line 4 of pseudo-code 300, and thus may be based on the set of training cells and the set of validation cells. The cell-importance tensor may be calculated via equation 5. The cell-important tensor may include a set of cell-importance cells with a one-to-one correspondence to the set of training cells. A cell-importance cell may be referenced as z. Each cell-importance cell may store a cell-importance metric, e.g., α_{z}. Each cell-importance metric may be based on the loss signal. Each cell-importance cell may correspond to one of the training cells (e.g., via the one-to-one correspondence) and the cell's stored cell-importance metric may indicates an influence of the corresponding training cell on the training of the first tensor-completion model. The cell-importance metric for each cell-importance cell may be based on employing an influence function that is based on the loss signal. The cell-importance calculator may employ the TRAM influence estimator to calculate the cell-importance metrics. The TRACIN influence estimator may employ equation 3 to calculate the cell-importance metrics.

At block 412, an entity-importance tensor may be generated based on the cell-importance tensor. An entity-importance calculator (e.g., entity-importance calculator 128 of FIG. 1) may be employed to generate the entity-importance array and calculate the entity-importance metrics stored in its cells. The entity-importance tensor may be a rank-1 tensor (e.g., a 1D array or a vector) and include a set of entity-importance cells. The set of entity-importance cells may have a one-to-one correspondence with the set of entities, and thus each entity-importance cell may correspond to one of the entities of the set of entities. Each entity-importance cell may store an entity-importance metric for the corresponding set of entities. That is, for each entity of the set of entities, an entity-importance metric for the entity may be calculated or determined based on a combination of the cell-importance metrics that are stored in a subset of the set of cell-importance cells that corresponds to the entity. The calculation of an entity-importance metric for entity i of the n^{th} dimension (e.g., αᵢ⁽ⁿ⁾) is referred to in line 5 of pseudo-code 300. The calculation of αᵢ⁽ⁿ⁾ may be carried out via equation 6.

The entity importance metric for an entity of the set of entities may indicate an influence of a subset of the training cells, which are associated with the entity, on the training of the first tensor-completion model, as indicated by the cell-importance metrics for the subset of training cells. The entity-importance metric for each entity-importance cell may be based on employing an influence function that is based on the loss signal.

At optional block 414, a second tensor-completion model may be trained. The second tensor-completion model may be trained as indicated in line 6 of pseudo-code 300. The second tensor-completion model may be trained based on the set of training cells. The second tensor-completion model may be referred to as Θₚ. The training of the second tensor-completion model may be performed as indicated by equation 1. A neural network trainer (e.g., neural network trainer 122 of FIG. 1) may be employed to train the second tensor-completion model based on the training tensor (e.g., by employing the set of training cells as training data). In some embodiments, the second tensor-completion model may be a CoSTCo model. In other embodiments, the second tensor-completion model may be a NTF model. In at least one embodiment, the second tensor-completion method may be a MLP model that employs a ReLU activation function.

At block 416, an augmented tensor may be generated based on data augmentation. The augmented tensor may be referred to as X_{aug}. The augmented tensor may be a tensor in [symbol] ^{I}^{₁}^{×I}^{₂}^{× . . . ×I}^{_{N}} with cells Ω_{aug}. An augmented data generator (e.g., augmented data generator 130 of FIG. 1) may be employed to generate the augmented tensor. The generation of the augmented tensor is referenced in lines 7-13 of pseudo-code 300. The augmented tensor may be further based on a weighted sampling of the set of entities. The weighted sampling of the set of entities may be based on the entity-importance tensor (e.g., the entity-importance metrics of the corresponding entities). The augmented tensor may include a set of augmented cells (e.g., Ω_{aug}). Each augmented cell of the set of augmented cells may be based on a stochastic sampling of the set of entities. The stochastic sampling may be performed and weighted by the entity-importance metric for each entity of the set of entities. More specifically, for each dimension of the target tensor, an entity of the set of entities may be selected based on the stochastic sampling of the set of entities. The augmented cell may be generated based on a combination of the selected entities for each of the dimensions of the target tensor.

At block 418, values (e.g., relevant values) may be predicted for the augmented tensor (e.g., for at least a portion of the set of augmented cells). More specifically, at block 418, the values of Ω_{aug} may be imputed or predicted by a trained value predictor (e.g., a trained neural tensor-completion model, such as but not limed to at least one of Θ or Θₚ. An incomplete cell predictor (e.g., incomplete cell predictor 132 of FIG. 1) may employ at least one of the first or the second tensor-prediction models to impute or predict values for the augmented tensor. That is, predicting the values for the augmented tensor may be based on at least one of the first or the second tensor-completion models. Predicting values for the augmented tensor is referenced in line 14 of pseudo-code 300. As such, each of the augmented cells of the set of augmented cells may store the corresponding determined value. In some non-limiting embodiments, a value for each augmented cell of the set of augmented cells may be determined based on the trained second tensor-completion model. Each of the determined values may be a relevant value. In at least one embodiment, block 418 may include determining a relevant value to store in each cell of the second subset of training cells. As noted above, determining a value may be based on the set of augmented cells and at least one of the first array-completion model or a second array-completion model.

At block 420, a final or new tensor may be generated based on a combination of the target tensor and the augmented tensor. The new tensor may be referenced as X_{new}, Generating the new tensor is referenced in line 15 of pseudo-code 300. In at least one embodiment, the complete tensor may be a new tensor that includes a union (e.g., a combination) of the first subset of target cells. The new tensor may store the relevant values determined in block 418. The complete tensor may be tensor that is outputted from the tensor completion engine (e.g., the completed output tensor 150 of FIG. 1).

FIG. 4B illustrates another embodiment of a method 440 for completing a tensor, which is consistent with the various embodiments presented herein. Process 440 may be performed by a tensor completion engine, such as but not limited to tensor completion engine 120 of FIG. 1. As such, pipeline 200 of FIG. 2 may implement any combination of the various steps, actions, operations, and/or functionalities associated with any of the blocks of method 440. Likewise, any of the blocks of method 440 may implement any combinations of the various steps, actions, operations, and/or functionalities associated with any of the four stages of pipeline 200. Furthermore, because pipeline 200 may implement various aspects of method 440, various blocks of method 440 may be implemented in pseudo-code 300 of FIG. 3, and vice-versa. That is, any of the lines of pseudo-code 300 may implement any of the aspects of method 440.

Process 440 begins, at block 442, where an incomplete target array (e.g., incomplete target tensor 140 of FIG. 1) and a training array may be received by a tensor completion engine (e.g., tensor completion engine 120 of FIG. 1). The incomplete target array includes a set of target cells. The set of target cells includes a first subset of target cells that store a relevant value and a second subset of target cells that store a non-relevant value. The training array may corresponding to the target array. The training array may includes a set of training cells. A set of entities may be associated with each of the target array and the training array. Each of the sets of training and target cells may be indexed via a set of indices. Each entity of the set of entities may be characterized by holding a specific value of a specific index of the set of indices constant while allowing values of other indices of the set of indices to vary across associated ranges.

At block 444, an entity-importance array may be generated by an entity-importance calculator (e.g., entity importance calculator 128 of FIG. 1). The entity-importance array may store an entity-importance metric for each entity of the set of entities. The entity-importance metric for an entity may be based on a training of a first array-completion model that employs the set of training cells. The entity-importance metric for an entity of the set of entities may indicate an influence of a subset of the training cells, which are associated with the entity, on the training of the first array-completion model.

At block 446, a set of augmented cells may be generated by an augmented data generator (e.g., augmented data generator 130 of FIG. 1). The set of augmented cells may be based on a stochastic sampling of the set of entities. The stochastic sampling may be weighted by the entity-importance metric for each entity of the set of entities. At block 448, an incomplete cell predictor (e.g., incomplete cell predictor 132 of FIG. 1) may determine relevant values for the incomplete target array. More specifically, a relevant value may be determined to store in a subset of the second subset of target cells based on the set of augmented cells.

FIG. 4C illustrates still another embodiment of a method 460 for completing a tensor, which is consistent with the various embodiments presented herein. Process 460 may be performed by a tensor completion engine, such as but not limited to tensor completion engine 120 of FIG. 1. As such, pipeline 200 of FIG. 2 may implement any combination of the various steps, actions, operations, and/or functionalities associated with any of the blocks of method 460. Likewise, any of the blocks of method 460 may implement any combinations of the various steps, actions, operations, and/or functionalities associated with any of the four stages of pipeline 200. Furthermore, because pipeline 200 may implement various aspects of method 460, various blocks of method 460 may be implemented in pseudo-code 300 of FIG. 3, and vice-versa. That is, any of the lines of pseudo-code 300 may implement any of the aspects of method 460.

Process 460 begins, at block 462, where an incomplete target array (e.g., incomplete target tensor 140 of FIG. 1) may be received by a tensor completion engine (e.g., tensor completion engine 120 of FIG. 1). The target tensor may have a set of target cells. The target tensor and/or the set of target cells may be associated with a set of entities. The set of target cells may include a first subset of target cells that store a relevant value and a second subset of target cells that store a non-relevant value. At block 464, a set of training cells corresponding to the set of target cells may be accessed.

At block 466, an entity-importance metric may be calculated for each entity of the set of entities. The calculation of the entity-importance metric for an entity may be based on a training of a first neural-based model that employs the set of training cells. At block 468, a relevant value may be determined to store in each cell of the second subset of target cells. The determination of a relevant value may be based on the entity-importance metric for each entity of the set of entities and at least one of the first neural-based model or a second neural-based model.

### Illustrative Computing Device

Having described embodiments of the present invention, an example operating environment in which embodiments of the present invention may be implemented is described below in order to provide a general context for various aspects of the present invention. Referring to FIG. 5, an illustrative operating environment for implementing embodiments of the present invention is shown and designated generally as computing device 500. Computing device 500 is but one example of a suitable computing environment and is not intended to suggest any limitation as to the scope of use or functionality of the invention. Neither should the computing device 500 be interpreted as having any dependency or requirement relating to any one or combination of components illustrated.

Embodiments of the invention may be described in the general context of computer code or machine-readable instructions, including computer-executable instructions such as program modules, being executed by a computer or other machine, such as a smartphone or other handheld device. Generally, program modules, or engines, including routines, programs, objects, components, data structures, etc., refer to code that perform particular tasks or implement particular abstract data types. Embodiments of the invention may be practiced in a variety of system configurations, including hand-held devices, consumer electronics, general-purpose computers, more specialized computing devices, etc. Embodiments of the invention may also be practiced in distributed computing environments where tasks are performed by remote-processing devices that are linked through a communications network.

With reference to FIG. 5, computing device 500 includes a bus 510 that directly or indirectly couples the following devices: memory 512, one or more processors 514, one or more presentation components 516, input/output ports 518, input/output components 520, and an illustrative power supply 522. Bus 510 represents what may be one or more busses (such as an address bus, data bus, or combination thereof). Although the various blocks of FIG. 5 are shown with clearly delineated lines for the sake of clarity, in reality, such delineations are not so clear and these lines may overlap. For example, one may consider a presentation component such as a display device to be an I/O component, as well. Also, processors generally have memory in the form of cache. We recognize that such is the nature of the art, and reiterate that the diagram of FIG. 5 is merely illustrative of an example computing device that can be used in connection with one or more embodiments of the present disclosure. Distinction is not made between such categories as “workstation,” “server,” “laptop,” “hand-held device,” etc., as all are contemplated within the scope of FIG. 5 and reference to “computing device.”

Computing device 500 typically includes a variety of computer-readable media. Computer-readable media can be any available media that can be accessed by computing device 500 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 500. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 512 includes computer storage media in the form of volatile and/or nonvolatile memory. Memory 512 may be non-transitory memory. As depicted, memory 512 includes instructions 524. Instructions 524, when executed by processor(s) 514 are configured to cause the computing device to perform any of the operations described herein, in reference to the above discussed figures, or to implement any program modules described herein. The memory may be removable, non-removable, or a combination thereof. Illustrative hardware devices include solid-state memory, hard drives, optical-disc drives, etc. Computing device 500 includes one or more processors that read data from various entities such as memory 512 or I/O components 520. Presentation component(s) 516 present data indications to a user or other device. Illustrative presentation components include a display device, speaker, printing component, vibrating component, etc.

I/O ports 518 allow computing device 500 to be logically coupled to other devices including I/O components 520, some of which may be built in. Illustrative components include a microphone, joystick, game pad, satellite dish, scanner, printer, wireless device, etc.

Embodiments presented herein have been described in relation to particular embodiments which are intended in all respects to be illustrative rather than restrictive. Alternative embodiments will become apparent to those of ordinary skill in the art to which the present disclosure pertains without departing from its scope.

From the foregoing, it will be seen that this disclosure in one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in a limiting sense, and the scope of embodiments is defined by the appended claims and their equivalents.

Various aspects of the illustrative embodiments have been described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features have been omitted or simplified in order not to obscure the illustrative embodiments.

Various operations have been described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B and C” means “(A), (B), (C), (A and B), (A and C), (B and C) or (A, B and C).”

What is claimed is:

1. A non-transitory computer-readable storage medium having instructions stored thereon, which, when executed by a processing device, cause the processing device to perform operations comprising:
receiving an array having a set of cells associated with a set of entities;
determining influence metrics of cells from the array based on an influence of the cells on minimizing loss while training a machine learning model;
generating an entity-importance metric for each entity of the set of entities based on the influence metrics; and
identifying a cell from the array for which to augment the array with a predicted value, the cell from the array being identified based on a sampling of the set of entities that is weighted by the entity-importance metric for each entity of the set of entities.

2. The computer-readable storage medium of claim 1, wherein the operations further comprise:
accessing a loss signal that was generated during the training of the machine learning model;
generating a cell-importance array that includes a set of cell-importance cells, wherein each cell-importance cell stores one of the influence metrics that is based on the loss signal; and
for each entity of the set of entities, determining the entity-importance metric for the entity based on a combination of the influence metrics that are stored in a subset of the set of cell-importance cells that corresponds to the entity.

3. The computer-readable storage medium of claim 2, wherein the loss signal includes a set of loss gradients generated during a plurality of epochs of the training of the machine learning model.

4. The computer-readable storage medium of claim 1, wherein the operations further comprise training the machine learning model by:
accessing a set of test cells and a set of training cells from the array; and
iteratively:
determining estimated values for the set of test cells based on current weights of the machine learning model determined using the set of training cells;
calculating a loss function based on a comparison between the estimated values for the set of test cells and observed values for the set of test cells; and
adjusting the current weights of the first machine learning model to decrease loss determined from the loss function.

5. The one or more computer-readable storage media of claim 1, wherein the operations further comprise:
for each entity of the set of entities, determining an entity-embedding based on the machine learning model;
for each training cell of a set of training cells, generating a cell-embedding based on a combination of the entity-embeddings for a subset of the set of entities that is associated with the training cell;
determining estimated values for a set of test cells based on the cell-embedding for each of the training cells of the set of training cells;
generating a loss signal based on the estimated values for the set of test cells; and
for each training cell of the set of training cells, determining the influence metric by employing an influence function that is based on the loss signal.

6. The one or more computer-readable storage media of claim 1, wherein the operations further comprise:
performing the sampling of the set of entities, wherein the sampling is a stochastic sampling of the set of entities;
for each dimension of the array, selecting an entity of the set of entities based on the stochastic sampling of the set of entities; and
wherein the cell from the array for which to augment the array with a predicted value is identified based on a combination of the selected entities for each of the dimensions of the target array.

7. The one or more computer-readable storage media of claim 1, wherein the operations further comprise:
determining, using the machine learning model or a second machine learning model, a relevant value to store in the identified cell from the array.

8. The one or more computer-readable storage media of claim 7, wherein the actions further comprise:
generating an augmented array that includes the identified cell storing the determined relevant value.

9. A method comprising:
receiving a tensor having a set of cells associated with a set of entities, the set of cells including a first subset of cells that store a relevant value and a second subset of cells that store a non-relevant value; and
generating an augmented tensor by:
selecting a cell from the second subset of cells of the tensor based on entity-importance metrics determined from training a first machine learning model using the tensor;
determining, using the first machine learning model or a second machine learning model, a relevant value to store in the selected cell of the tensor; and
storing the relevant value in the selected cell of the tensor.

10. The method of claim 9, wherein generating the augmented tensor further comprises:
calculating an entity-importance metric for each entity of the set of entities based on the training of the first machine learning model.

11. The method of claim 10, wherein generating the augmented tensor further comprises:
accessing a loss signal that was generated during the training of the first machine learning model using a set of training cells from the tensor;
calculating, based on the loss signal, a cell-importance metric for each training cell of the set of training cells from the tensor; and
wherein, for each entity of the set of entities, the entity-importance metric for the entity is determined based on a combination of the cell-importance metrics that corresponds to the entity.

12. The method of claim 11, wherein the loss signal includes a set of loss gradients generated during a plurality of epochs of the training of the first machine learning model.

13. The method of claim 9, wherein the operations further comprise training the machine learning model by:
accessing a set of training cells and a set of test cells from the tensor; and
iteratively:
determining estimated values for the set of test cells based on current weights of the first machine learning model;
calculating a loss function based on a comparison between the estimated values for the set of test cells and observed values for the set of test cells; and
adjusting the current weights of the first machine learning model to decrease loss determined from the loss function.

14. The method of claim 9, further comprising:
for each entity of the set of entities, determining an entity-embedding based on the first machine learning model;
for each training cell of a set of training cells, generating a cell-embedding based on a combination of the entity-embeddings for a subset of the set of entities that is associated with the training cell;
determining estimated values for a set of test cells based on the cell-embedding for each of the training cells of the set of training cells;
generating a loss signal based on the estimated values for the set of test cells; and
for each training cell of the set of training cells, determining an influence metric by employing an influence function that is based on the loss signal, wherein the entity-importance metrics are determined using the influence metrics.

15. The method of claim 9, wherein selecting the cell from the second subset of cells comprises:
performing stochastic sampling of the set of entities;
for each dimension of the tensor, selecting an entity of the set of entities based on the stochastic sampling of the set of entities; and
wherein the cell from the second subset of cells is selected based on a combination of the selected entities for each of the dimensions of the target array.

16. A system comprising:
a memory device; and
a processing device, operatively coupled to the memory device, to perform operations comprising:
receiving a tensor having a set of cells associated with a set of entities;
training a first machine learning model using a set of training cells from the tensor;
determining cell-importance metrics for the training cells based on a loss signal determined from training the first machine learning model;
determining, for each entity from the set of entities, an entity-importance metric based on a combination of cell-importance metrics for training cells associated with the entity;
selecting a cell from the tensor based on the entity-importance metrics for a subset of entities associated with the cell;
determining, using the first machine learning model or a second machine learning model, a value for the selected cell of the tensor; and
generating an augmented tensor that stores the value in the selected cell.

17. The system of claim 16, wherein the loss signal includes a set of loss gradients generated during a plurality of epochs of the training of the first machine learning model.

18. The system of claim 16, wherein selecting the cell from the tensor comprises:
performing stochastic sampling of the set of entities;
for each dimension of the tensor, selecting an entity of the set of entities based on the stochastic sampling of the set of entities; and
wherein the selected cell is identified based on a combination of the selected entities for each of the dimensions of the target array.

19. The system of claim 16, wherein training the first machine learning model comprises:
accessing the set of training cells and a set of test cells from the tensor; and
iteratively:
determining estimated values for the set of test cells based on current weights of the first machine learning model;
calculating a loss function based on a comparison between the estimated values for the set of test cells and observed values for the set of test cells; and
adjusting the current weights of the first machine learning model to decrease loss determined from the loss function.

20. The system of claim 16, wherein determining the cell-importance metrics for the training cells comprises:
for each entity of the set of entities, determining an entity-embedding based on the first machine learning model;
for each training cell of the set of training cells, generating a cell-embedding based on a combination of the entity-embeddings for a subset of the set of entities that is associated with the training cell;
determining estimated values for a set of test cells based on the cell-embedding for each of the training cells of the set of training cells;
generating the loss signal based on the estimated values for the set of test cells; and
wherein the cell-importance metric for each training cell is determined by employing an influence function that is based on the loss signal.
